(19) United States
(12) Patent Application Publication
(10) Pub. No.: US 2026/0357769 A1
(43) Pub. Date: Nov. 12, 2026

(54) HYBRID ENGINE FOR A PROJECTILE

(71) Applicant: BAE SYSTEMS BOFORS AB, Karlskoga (SE)

(72) Inventor: David Malmstrom, Karlskoga (SE)

(21) Appl. No.: 19/157,150

(22) PCT Filed: Jan. 30, 2024
(86) PCT No.: PCT/SE2024/050078

§ 371 Date: Aug. 15, 2025

(30) Foreign Application Priority Data
Feb. 16, 2023 (SE) 2300013-6

(51) Int. Cl. F02K 9/97; F02K 9/08; F42B 10/30; F42B 10/40

(52) U.S. Cl. CPC F02K 9/97; F02K 9/08; F42B 10/30; F42B 10/40

(57) ABSTRACT

The invention relates to a hybrid engine (10) for projectiles in which a rocket engine with an annular nozzle (7) is arranged along with a base bleed unit with a circular nozzle (8) where the circular nozzle (8) of the base bleed unit is arranged centered in the annular nozzle (7) on the rocket engine and where the hybrid engine (10) is arranged with a propellant charge for the rocket engine (2) and a propellant charge for the base bleed unit (5). The invention further relates to a projectile (100) outfitted with a hybrid engine.

### CROSS-REFERENCE TO RELATED APPLICATIONS

The present application is a National Stage entry of PCT Application No. PCT/SE2024/050078, entitled “HYBRID ENGINE FOR A PROJECTILE” , filed Jan. 30, 2024, which claims priority to SE Application No. 2300013-6, entitled “HYBRID ENGINE FOR A PROJECTILE” , filed Feb. 16, 2023, the disclosures of which are incorporated by reference herein in their entireties.

### TECHNICAL FIELD

The present invention relates to a hybrid engine for a projectile where a rocket engine with an annular nozzle is arranged along with a base bleed unit with a circular nozzle where the circular nozzle on the base bleed unit is arranged centered in the annular nozzle on the rocket engine and that the hybrid engine is arranged with a propellant charge for the rocket engine and a propellant charge for base bleed units. The invention further relates to a projectile outfitted with a hybrid engine.

### BACKGROUND

Several different methods of increasing the range of projectiles fired from firearms are known and can be divided into three groups:
1. weapon solution—the projectile is given a higher exit velocity,
2. additional impulse—the projectile is provided with an energy source that gives an increased speed in the trajectory,
3. ballistic solution—causes the projectile to lose velocity more slowly after firing.

The first means- weapon solutions—based on the established values of muzzle energy and on ensuring that the maximum pressure is not exceeded for existing weapon solutions—only allows for a higher output velocity through the reduction of the projectile's weight. In practice, however, a significant increase in the firing range is only obtained if the cross-sectional area of the projectile is simultaneously reduced. This in turn reduces the effect that the projectile can have on the target as the size of the warhead is reduced.

The second means—additional impulse—for example by arranging a rocket engine on the projectile—is suitable for rotationally stabilized projectiles and provides a good performance improvement. The main disadvantages are the increased cost that rocket engines entail, and the fact that the probability of hitting the target is diminished, as the rocket engine takes up space in the projectile and thus reduces the size of the warhead.

The third means for increasing the firing range is to reduce the aerodynamic resistance throughout the trajectory. This can be achieved in the following ways, either individually or in combination,
Undercalibration
Low resistance design
Base flow aggregate

The first method, undercalibration, means that the projectile has a smaller diameter than the barrel, so it must be fitted with a driving mirror. A smaller projectile diameter results in a reduced effect on the target as the size of the warhead is reduced. Low-drag design brings about aerodynamic adaptation, for example through the design of an aft cone. However, the design of an aft cone has other technical problems related to manufacture and, as in the previous case, the size of the warhead is reduced. The most established solution presently is the introduction of a base bleed unit that improves the shooting range without having too much of an impact on the space of the effective part.

Patent document CN 113153580 B describes a rocket engine comprising a combined nozzle with an outer movable nozzle and an inner fixed nozzle. Through the outer movable nozzle, an altered vectorized thrust can be brought about. The described rocket engine shows that a common propellant charge is used by the rocket engine and shows no base bleed unit.

Patent document WO 2021/074553 A1 describes a rocket engine arranged with a nozzle in the form of an aerospike design. The described rocket engine is of hybrid design and comprises a combination of solid and liquid propellant for the rocket engine. The described rocket engine does not include a base bleed unit.

A solution to the problem above and additional problems along with solutions are described below.

### SUMMARY OF THE INVENTION

One purpose of the present invention is to solve the issues identified above relating to an improved hybrid engine for projectiles, comprising partly an impulse engine in the form of a rocket engine and partly a base bleed unit combined in a limited volume so as not to affect the projectile's ability to carry a load to a major extent.

A further purpose of the present invention is a hybrid engine for projectiles, where a rocket engine with an annular nozzle is arranged along with a base bleed unit with a circular nozzle, where the circular nozzle of the base bleed unit is arranged centered in the annular nozzle of the rocket engine, where the hybrid engine is arranged with a propellant charge for the rocket engine and a propellant charge for the base bleed unit, where the propellant charge for the base bleed unit creates a gas flow that is directed out through the circular nozzle, and where the propellant charge for the rocket engine creates a gas flow that is directed out through the annular nozzle. The annular nozzle and the circular nozzle are arranged separately without any gas flow being possible between the different nozzles. No gas flow generated by the propellant for the base bleed unit is able to flow through the annular nozzle and no gas flow generated by the propellant for the rocket engine is able to flow through the circular nozzle.

According to further aspects for a hybrid engine according to the invention, the following applies:
that the nozzle for the rocket engine is of aerospike type.
that the propellant charge for the rocket engine and the propellant charge for the base bleed unit consist of a solid propellant, where said propellant is gunpowder.
that the annular nozzle rocket engine surrounds the base bleed unit with a circular nozzle.
that the propellant charge for the rocket engine is arranged with a powder support.
that the rocket engine propellant is ignited by a rocket engine igniter.
that the propellant charge for the base bleed unit is ignited by a base bleed igniter.
that the combustion time for the propellant charge for the rocket engine is between 5 sec-20 sec depending on the caliber of the projectile.
that the combustion time for propellant charge for the base bleed unit is greater than 10 sec.

The invention further consists of a projectile outfitted with a hybrid engine including a rocket engine and a base bleed unit as per the above.

### BRIEF DESCRIPTION OF THE DRAWINGS

The invention will be described below by reference to the figures that are included there:

FIG. 1 shows a hybrid engine in a cross-sectional view according to an embodiment of the invention.

FIG. 2 shows a projectile in a cross-sectional view according to an embodiment of the invention.

### DETAILED DESCRIPTION OF THE DRAWINGS

The present invention shows a new and alternative design for hybrid engine for projectiles.

An ejection device, also termed a cannon, a howitzer, or a piece, in the sense of an artillery piece, has the goal of making use of a propellant for the purpose of firing a projectile. Preferably, a propellant, such as gunpowder, is initiated in one part of the cannon, oftentimes a chamber specifically adapted to the purpose. Initiation takes place by way of igniting the propellant, for instance by means of an ignition cartridge or an igniter in a munition device, which is initiated by means of striking. Other methods for igniting the propellant may include ignition of the propellant by means of laser energy or electric energy. The propellant burns at a high rate and results in large amounts of gas being produced, which creates a gas pressure in the chamber which propels the projectile out of the barrel of the firing device. The propellant has been adapted in order to generate a constant pressure on the projectile during the entire barrel procedure, to the greatest extent possible, as the projectile moves in the barrel, which results in the projectile leaving the muzzle of the barrel with high speed.

Projectiles, such as various types of grenades, generally include some form of warhead and some form of barrel which initiates the warhead. Fuzes can be of different types where contact fuzes are common for projectiles that are meant to burst when in contact with an object, timed fuzes when the projectile is meant to burst at a certain predetermined time and proximity fuzes when the projectile is meant to burst when an object comes within a certain distance from the projectile. The use of proximity fuzes is preferred when confronting flying vessels, while timed fuzes can be used when confronting a large number of various different objects. It is advantageous to combine various types of fuze functions in one and the same fuze, for instance in order for the projectile to burst after a certain time if it fails to detect any object, and so on.

It is advantageous for the warhead to comprise some type of explosive substance, as well as some type of shattering casing which encloses the explosive substance. Various types of propellants, such as fins, can furthermore be arranged in either the barrel or in their own subcomponent.

In order to stabilize the projectiles once the projectiles have left the barrel, the projectiles are preferably designed with rotation or with fins. In cases where the projectiles are designed with rotation, the projectiles are said to be rotationally stabilized and in cases where the projectiles are arranged with fins, the projectiles are said to be fin stabilized. Fin-stabilized projectiles should have no rotation, or very low rotation, when leaving the barrel.

To achieve rotation on the projectiles, the barrel is often designed with rifling, to which the projectile connects during the firing process. Rifling means that the barrel in a firearm, the barrel, is provided with spiral-shaped rifling. The opposite is a smooth-bore barrel. When the rifling engages the projectile during firing, it rotates along its longitudinal axis. Due to the rotation, minor irregularities or damage to the projectile will not cause a drift. Rotation is also necessary for an elongated (torpedo-shaped) projectile to maintain its direction after leaving the barrel and not start tumbling around. This is referred to as the projectile being rotation-stabilized. In smooth-bore weapons, only round (spherical) projectiles or fin-stabilized projectiles can be fired. An elongated projectile without fins will tumble as it leaves the muzzle.

Thus, rifling consists of grooves that are integrated into the track of the barrel, and the elevation in between is referred to as barriers. The rifling of fine-caliber firearms usually consists of four grooves that are turned to the right, while cannons, such as artillery pieces, have more grooves depending on the caliber of the launching device. In order for the rifling to be able to engage the projectile, the projectile must either be slightly larger than the diameter between the barriers, which is common for fine-caliber weapons, or be equipped with a special flange, called a belt, which has a slightly larger diameter than the barriers, which is common in projectiles with a diameter greater than 20 mm. The belt can be made out of plastic, composite material, or a soft metal, such as brass. The length of the barrel on which the groove rotates an entire revolution is called pitch and is usually the number of inches per revolution. A pitch of 1:10 inches means that the projectile rotates a revolution of 10 inches. The corresponding pitch in millimeters is written 1:254 mm. The pitch is adjusted so that the projectile obtains the initial rotational speed required for it to maintain the required stability throughout its trajectory from launch to target, i.e. without losing its stability and starting to tumble around.

Most barrels include rifling, and, by arranging projectiles with sliding belts, both rotation-stabilized and fin-stabilized projectiles can be launched with rifled barrels. Smooth-bore barrels are basically only used for weapon systems intended to armored combat vehicles, as the rotation of the projectile means that the directed explosive action, RSV, is less effective since the centrifugal force causes the beam from RSV to be spread out.

One method to increase the firing distance of artillery shells, as well as to reduce the firing time for anti-aircraft and armor projectiles, through gas flow in the rear of the projectile, is known as base bleed. This technique entails a fuel being burned in the rear part of the projectile and thus generates a mass flow, essentially gaseous, which flows out, and is usually combusted, adjacent to the base plane/aft of the shell/projectile. The purpose of base bleed is primarily to reduce base drag and thus does not provide any driving force to the projectile.

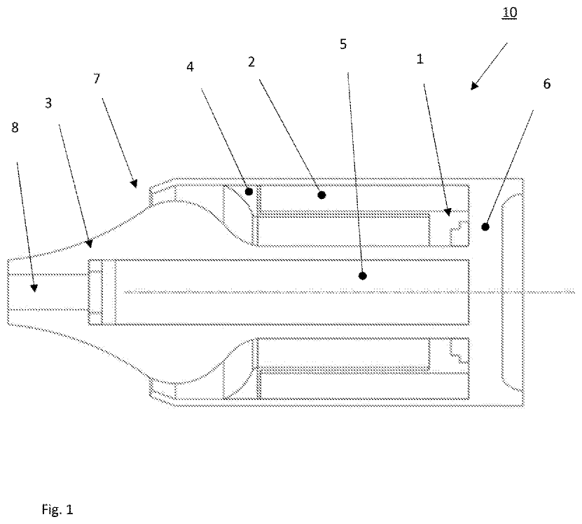

FIG. 1 shows a cross-section of a hybrid engine 10 comprising a base bleed unit, comprising a nozzle 8, a propellant charge for base bleed unit 5 and a base bleed igniter 3, as well as a rocket engine, comprising a propellant charge for rocket engine 2, a rocket engine igniter 1, a propellant support for the propellant charge for rocket engine 4 as well as an aerospike nozzle 7. Aerospike is a type of nozzle, also known as an inverted nozzle, since the nozzle, from a technical perspective, consists of several conventional bell nozzles that have been turned inside out. The Aerospike nozzle is an annular nozzle, that is, a nozzle consisting of an annular opening with an inner radius and an outer radius. Nozzle 8 is a conventional circular nozzle, i.e. a nozzle shaped like a circular opening, like a hole with a certain diameter, through which the gas can flow.

From the inflowing combustion gases when the propellant is burned in the launch device, both the base bleed igniter 3 and the propellant charge for the base bleed unit 5 will be ignited, and the propellant charge for rocket engine 2 and rocket engine igniter 1 will also be ignited. At a certain value of the pressure—the forcing pressure—the projectile will begin to move, whereby the belt, not shown in the figure, is pressed into grooves in the barrel. During the acceleration in the barrel, the drive charge for base bleed unit 5 will be pressed backwards during simultaneous shape change, which is why both design and choice of material of the drive charge for base bleed unit 5 are important to ensure the functionality of the base bleed. Similarly, the propellant charge for the rocket engine 2 will be pushed backwards and radially during simultaneous shape change, which is why both the design and the choice of material of the propellant charge for rocket engine 2 are important to ensure the functionality of the base bleed. The propellant charge for rocket engine 2 can also be provided with a propellant support, for example made from a polymer, to improve the ability of the propellant charge to handle the axial and/or radial forces during launch. Design of powder support 4 can also affect how the propellant charge for rocket engine 2 is initiated, for example by delaying the initiation of the propellant charge for rocket engine 2 until after the projectile has left the barrel.

When the projectile leaves the barrel, the axial acceleration ceases. Due to the viscoelastic properties of the gunpowder and the large centripetal acceleration due to the rotation, the charge not only returns to its original length, but will be extended until it abuts the front end. Thus, the load becomes hydrostatic as a result, even in this case.

During the passage through the muzzle, the pressure inside both the base bleed chamber and the rocket engine will be of the same order of magnitude as the muzzle pressure, while the pressure outside the base bleed device and the rocket engine will quickly drop to atmospheric pressure. The base bleed device and the rocket engine will thereby be exposed to a high internal pressure and must be dimensioned with this in mind. Through the relatively large nozzles 7 and 8, however, the pressure will be equalized very quickly. Due to the rapid pressure drop after the passage through the muzzle, the design is adapted so as to prevent the extinguishing of the propellant charge for base bleed unit 5. In addition, base bleed igniter 3 is adapted to burn even while exposed to strong pressure changes. In the same way, the propellant charge for the rocket engine 2 and the rocket engine igniter 1 are adapted.

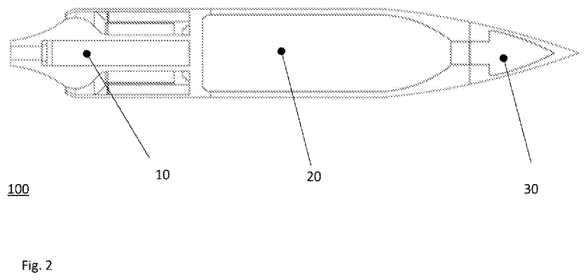

FIG. 2 shows a projectile 100 outfitted with a hybrid engine 10, an action part 20 and a fuze 30. Fuze 30 can be adapted based on the function of the warhead and can, for example, be made of impact fuzes, timed fuzes and/or proximity fuzes. The warhead can also be adapted based on the projectile's 100 areas of use, but in most contexts, it includes explosives and a shell with a shrapnel effect, but other forms of effect can also be relevant. FIG. 2 illustrates that hybrid engine 10 takes up relatively little space on the projectile and can be arranged for most commonly known projectile variants.

A launching device is provided for firing, firing, projectiles with a propellant charge. The propellant charge, which can be gunpowder, for example, burns after initialization and generates a high pressure that drives the projectile out of a barrel. The projectile is arranged in the barrel by a method called hiring, it is common for a belt enclosing the projectile to be deformed relative to a groove arranged in the barrel which retains the projectile in the barrel. The propellant charge is arranged in what is often called a chamber in which the propellant charge is combusted during the generation of gases, gunpowder gases, which cause the projectile to move in the barrel. Preferably, a continuous/constant pressure is created in the chamber which also fills the barrel with pressurized gas behind the projectile as it moves towards the muzzle of the barrel. When the propellant charge is initiated, the rocket engine igniter and the base bleed igniter are also ignited and, in addition, if desired and arranged, propellant charge for the base bleed unit and propellant charge for the rocket engine. When the projectile leaves the muzzle of the barrel, a strong drop in pressure will affect the rocket engine and the base bleed unit, which is why both the rocket engine igniter, the base bleed igniter, the propellant charge for the base bleed unit and the propellant charge for the rocket engine have been adapted to cope with the pressure change. At a certain time, for example right after the projectile leaves the barrel, the rocket engine is initiated and gives the projectile an impulse. At the same time, the base bleed generator is initialized and generates a constant base bleed. The rocket engine often burns relatively quickly, for example between 5 sec and 20 sec, and thus creates an impulse on the projectile. However, the base bleed unit should preferably burn during the entire time that it takes the projectile from the launch device to reach the target. The burning time for the base bleed unit is thus preferably over 10 sec. Depending on the caliber of the projectile, the burn time can change for the base bleed unit where medium caliber projectiles have a significantly shorter burn time relative to coarse caliber projectiles.

Problems with firing projectiles arranged with a belt included the belt causing wear on the barrel as we as the seal between the projectile and the barrel loosening, thus enabling the entry of gunpowder gases, which affects the launch process, among other things by the fact that it results in the projectile launch speed, V0, varying between different projectiles depending on differences in the seal between the projectile and the barrel.

The combination of projectile length, weight, and design determines the rotational speed required to stabilize the projectile. In general, short projectiles with a high diameter (coarse caliber) require a lower rotational speed compared to long projectiles with a small diameter (fine caliber). Barrels can also be manufactured with progressively increasing pitch. Extremely long projectiles, such as dart ammunition, also called flechette, can be difficult to rotationally stabilize, which is why they are instead preferably fin stabilized.

For best performance, the barrel should have a pitch that is high enough for the projectile to have such a high rotational speed that the projectile is rotationally stabilized, but the pitch should not be so large that the rotational speed is much higher than is required to achieve rotational stabilization. Coarser projectiles lead to better stabilization when a higher momentum is achieved, while elongated projectiles have an aerodynamic pressure point with leverage, which results in lower stability.

Different forms of gunpowder are preferably used for the propellant charge for the launch device, the rocket engine igniter, the base bleed igniter, the propellant charge for the base bleed and the propellant charge for the rocket engine. Gunpowder is often divided into the groups of barrel gunpowder and rocket gunpowder, since two relatively different properties are required for each gunpowder. In a barrel, it is desirable to achieve high pressures (several hundreds of MPa) for a short time (a few ms), while, for a rocket, it is rather desirable to obtain a reasonably constant pressure (tens of MPa) for a longer time (sec-min). From a chemical point of view, however, some rocket and barrel propellants are very similar. In order to evaluate the performance of a certain barrel gunpowder, one can rely on the specific force, which is often stated in MJ/kg, which is not the same as the gunpowder's energy content. A high-performance barrel powder has a high specific force. For rocket powder, one can instead rely on the corresponding measure of specific impulse, which is given in Ns/kg. A high-performance propellant has a high specific impulse.

The geometric shape of the powder is very important for the performance of the powder. The amount of gas produced when the gunpowder burns is proportional to the burning speed and the burning surface. The burning surface is dependent on the shape and porosity of the gunpowder, which means that the gunpowder can take on a different appearance depending on the intended manner of producing the gas. As a result, names such as sheet gunpowder, stick powder and multi-hole gunpowder can be observed in a propellant context.

Common military powders are, for example, nitrocellulose powder, NC powder, or single base powder, which is a solid substance produced by gelatinizing nitrocellulose with ethanol and ether. Another more historical name for this gunpowder is cotton gunpowder. The single-base gunpowder is somewhat sensitive to moisture, which can reduce the gunpowder's performance. Single-base powder is used in the ammunition for firearms and artillery pieces. Nitroglycerin gunpowder, NCGL gunpowder, or double-base gunpowder is a solid produced by gelatinizing nitrocellulose with nitroglycerin. The double-base gunpowder has more energy than the single-base gunpowder and less sensitive to moisture. A disadvantage of this type of gunpowder is that the combustion temperature is high, which contributes to barrel wear. Double-base powder is used in the ammunition for, among other weaponry, tank guns and anti-aircraft pieces where high exit velocities are desired.

Nitroguanidine gunpowder or triple base gunpowder is a solid substance produced by mixing double-base gunpowder with nitroguanidine. Triple-base gunpowder is not sensitive to moisture and does not have as much energy as double-base gunpowder, but has the advantage that the barrel wear and muzzle flame are less than when using double-base gunpowder. The triple-base gunpowder is mainly used in ammunition for larger guns and artillery pieces. All the above-mentioned powders, which are based on nitrocellulose, are also called low-smoke powders, mainly due to the fact that the comparative powder was black powder, which generated extensive smoke development. Double-base powder is used both as cannon powder and as rocket powder. Composite gunpowder is a solid substance that is produced by mixing an oxygen-rich salt with a binder and possibly also with an additional fuel such as a metal. The most common nowadays is to use ammonium perchlorate, AP, as an oxygen emitter, and to use a thermosetting plastic, polymer, as a binder, as well as a fuel. Aluminum is often also used in order to increase the specific impulse. The composite gunpowder can be made very high in energy and given a high specific impulse (over 2.600 Ns/kg). A disadvantage of the composite gunpowder of the type mentioned above is that it emits a clear streak of smoke, especially in moist air, and always when it contains aluminum. Composite gunpowder is used in rocket engines for, for example, missiles or launch rockets.

An example caliber for a projectile arranged with hybrid engine is 20-155 mm.

The invention is not limited to the embodiments specifically shown, but can be varied in different ways within the framework of the claims.

For instance, it is clear that the number, size, material, and shape of the elements included in the projectiles, as well as the details, are to be adapted according to the projectile(s) and projectile compositions, along with other construction-related properties, which are applicable to each individual case.

For instance, the projectile can be arranged so that it is capable of exploding, emitting shrapnel, catching fire, exerting a thermobaric effect, fighting fires, to be used as a training projectile, in light kits, in smoke kits, to exert electromagnetic effect, bring about electromagnetic disturbances or other loads and functions.

1. A hybrid engine for a projectile characterized in that a rocket engine with an annular nozzle is arranged along with a base bleed unit with a circular nozzle; where the circular nozzle of the base bleed unit is arranged centered in the annular nozzle of the rocket engine,
and in that the hybrid engine is arranged with a propellant charge for the rocket engine and a propellant charge for the base bleed unit,
where the propellant charge for the base bleed unit creates a gas flow that is led out through the circular nozzle,
and in that the propellant charge for the rocket engine creates a gas flow that is directed out through the annular nozzle.

2. The hybrid engine for the projectile according to claim 1, characterized in that the nozzle for the rocket engine is of aerospike type.

3. The hybrid engine for the projectile according to claim 1, characterized in that the propellant charge for the rocket engine and the propellant charge for the base bleed unit consists of a solid propellant, where the solid propellant is gunpowder.

4. The hybrid engine for the projectile according to claim 3, characterized in that the rocket engine with an annular nozzle encloses the base bleed unit with a circular nozzle.

5. The hybrid engine for the projectile according to claim 1, characterized in that the propellant charge for the rocket engine is arranged with a gunpowder support.

6. The hybrid engine for the projectile according to claim 1, characterized in that the propellant charge for the rocket engine is ignited by a rocket engine igniter.

7. The hybrid engine for the projectile according to claim 1, characterized in that the propellant charge for the base bleed unit is ignited by a base bleed igniter.

8. The hybrid engine for the projectile according to claim 1, characterized in that a combustion time for the propellant charge for the rocket engine is between 5 sec-20 sec depending on the caliber of the projectile.

9. The hybrid engine for the projectile according to claim 1, characterized in that a combustion time of the propellant charge for the base bleed unit is greater than 10 sec.

10. A projectile including a hybrid engine comprising a rocket engine and a base bleed unit according to claim 1.
